(19) United States
(12) Patent Application Publication
(10) Pub. No.: US 2004/0218089 A1
(43) Pub. Date: Nov. 4, 2004

(54) Ruggedized remote monitoring system and method

(76) Inventor: Rigby J. Heusinkveld, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/940,820

(22) Filed: Aug. 28, 2001

(51) Int. Cl. H04N 5/225

(52) U.S. Cl. 348/370

(57) ABSTRACT

A system and method for a visual communication system is disclosed comprising a camera for capturing images, an electronic display for displaying the images captured by the camera, a communication interface for communicating the captured images, and a rugged casing protecting the electronic display, the camera, and the communication interface.

### TECHNICAL FIELD

The present application relates in general to multimedia communications, and more particularly, to a system and method for providing remote monitoring from a ruggedized package.

### BACKGROUND OF THE INVENTION

In the services industry, there is typically an effort made to improve the relationship with the consumer as well as to improve the consumer's experience. These goals usually entail increasing the involvement of the consumer in the particular service being offered. When the consumer feels informed regarding any decisions that need to be made, or is shown the steps and progress of the service, the consumer is more likely to feel satisfied with the service and the service provider. For example, if an auto mechanic shows a torn or worn-out belt to the car owner, the consumer will likely feel more confident in approving the repair than he or she would if the consumer merely talks to the mechanic on the telephone. Without actually viewing the malfunctioning part, the consumer may feel that the mechanic is trying to perform an unnecessary service.

In another example, a contractor may encounter a problem with a remodeling project that requires the consumer to view an item or make a choice between two items. If the contractor makes the choice, he or she runs the risk of doing something that the consumer does not like. If the contractor must wait for the consumer to visit the work site, valuable time may be wasted. In order to provide the most pleasing experience, the service provider would generally have to have the consumer wait at the service location for the duration of the service. While this practice would allow the consumer the most hands-on experience with the service being provided, it is not practical for consumers who must work or who do not wish to stand around idly waiting for some unknown event.

Some newer systems which take advantage of digital and computer technology allow for cameras to be installed in service locations. The cameras may generally connect to the Internet to display the captured images. Consumers may then access the Internet to view the images from the camera. One such application gaining popularity are the day care cameras that allow parents to access the current status of the day care their children may attend. While this solution provides greater access by the parent, the typical cameras and apparatus used to implement the service are too delicate to use in the more harsh environments of an auto shop or a construction/remodeling site. Furthermore, in situations such as the construction site, the current methods do not provide the portability to bring such equipment temporarily into the job at a reasonable cost.

### BRIEF SUMMARY OF THE INVENTION

The present invention is directed to a system and method for a visual communication system comprising a camera for capturing images, an electronic display for displaying the images captured by the camera, a communication interface for communicating the captured images, and a rugged casing protecting the electronic display, the camera, and the communication interface.

### BRIEF DESCRIPTION OF THE DRAWINGS

FIG. 1 is a perspective view illustrating a preferred embodiment of the present invention configured with a laptop computer;

FIG. 2 is a perspective view illustrating an alternative embodiment of the present invention;

FIG. 3 is a is a perspective view illustrating a further alternative embodiment of the present invention configured with a personal data assistant; and

FIG. 4 is a flow chart representing the steps performed in implementing a preferred embodiment of the present invention.

### DETAILED DESCRIPTION OF THE INVENTION

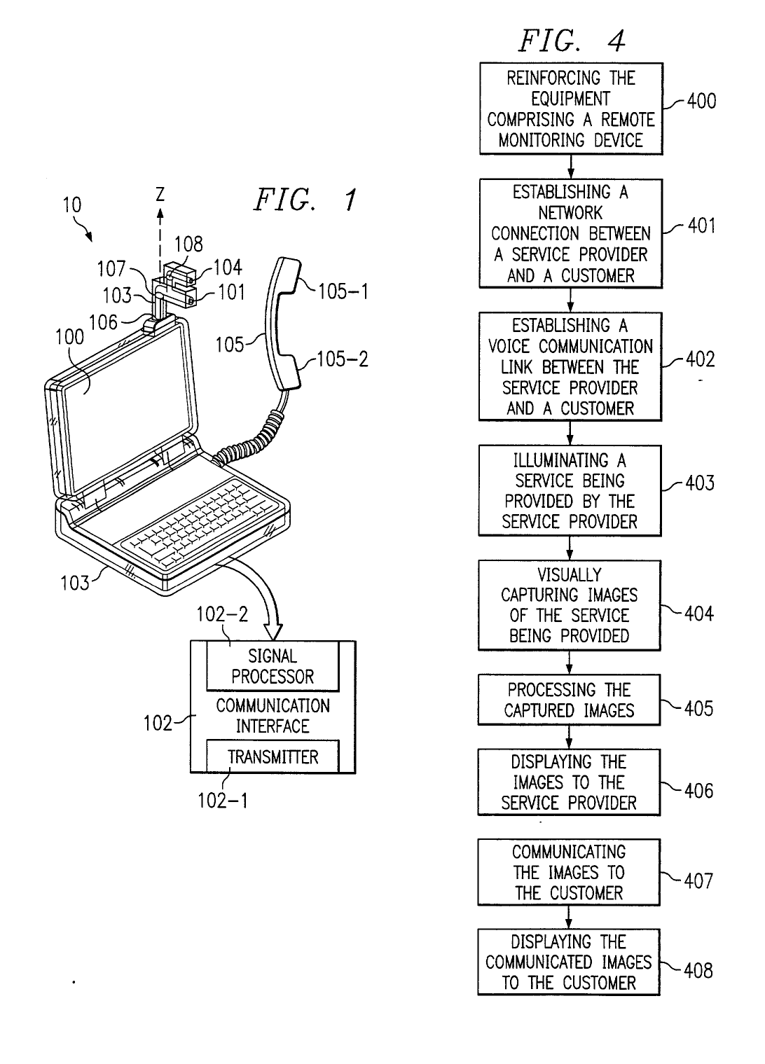

FIG. 1 illustrates a preferred embodiment of the present invention configured using a laptop computer. Remote monitor 10 preferably includes display 100 and camera 101, with attached light source 104, all covered with rugged casing 103 to protect each of the elements of remote monitor 10. Within remote monitor 10, communication interface 102 preferably controls the communication of multimedia data. Handset 105 is preferably connected to remote monitor 10 to allow the service technician to receive audio data through speaker 105-1 and send audio data through microphone 105-2 both to and from a remote consumer. Communication interface 102 preferably includes transceiver 102-1 for wirelessly transmitting and receiving the multimedia data to a remote location and signal processor 102-2 for processing the out-going and in-coming multimedia data.

In operation, the service technician may preferably manipulate camera 101, with attached light source 104, to point at and capture any image related to the service being performed. Camera 101 may be rotated around a z-axis at rotatable pivot 106 to maneuver camera 101 to point at the image. Additionally, camera 101 may be rotated about hinge 107 to point camera up or down along the z-axis shown in FIG. 1. Similarly, light source 104 may also be rotated about hinge 108 to pan the light up or down the z-axis. Camera 101 may preferably capture either still or video images. The captured images may optionally be displayed to the service technician on display 100 and also preferably processed for communication by signal processor 102-2 of communication interface 102. The service technician may also preferably initiate or facilitate verbal communication with a remote user by using handset 105. Remote monitor 10 may either establish an audio connection with a remote user over a standard telephone line or wireless telephone system, or may establish a digital audio connection, such as, by way of example and not for limitation, with voice over Internet protocol (VoIP) technology, through a computer network, such as the Internet.

The images captured by camera 101 may then preferably be communicated to a remote user by transmitting the processed images through transceiver 102-1. Depending on the speed or availability of the remote consumer's Internet connection, remote monitor 10 may either send streaming, multimedia video images of the service project, or may send individual still images through e-mail or other non-time critical communication protocols. The remote consumer will then preferably be able to view the service project and answer any questions or give any directions to the service provider. For example, if a contractor needed the exact location to place a window or to install a communication outlet, the contractor would maneuver camera 101 with attached light source 104 to preferably capture the image of the general vicinity of the service. The captured image would preferably be displayed on display 100 to assist the service provider in capturing the correct images. The captured images would then preferably be transmitted in communication interface 102 through transceiver 102-1 to a point at which the remote consumer would be able to access the transmitted images. The service provider would also preferably initiate an audio connection with the remote consumer through handset 105. By viewing the captured images and being audibly connected to the service provider, the remote consumer would preferably be able to provide detailed instructions to the contractor as to the exact location to perform the service.

It should be noted that rugged casing 103 preferably allows the service provider to place remote monitor 10 into many different positions. Rugged casing 103 will prevent remote monitor 10, camera 101, and attached light source 104 from being damaged by reasonably sized debris or other matter that may be present at a work site.

FIG. 2 illustrates an alternative embodiment of the present invention configured as a larger unit that preferably incorporates standard camera 201 and telescoping miniature camera 205. Monitor station 20 also preferably includes monitor 200, light 204, microphone 206, and speaker 207. Monitor station 20 is preferably connected to Internet 22 through communication interface 202. The entire system is preferably protected by reinforcing shell 203.

FIG. 2 illustrates an example use for monitor station 20 in an auto shop. In operation, a mechanic may initiate communication with a remote user by calling the user on user's telephone 24 to discuss a repair situation on automobile 21. The mechanic preferably speaks to the remote user through microphone 206 and hears all audible responses from the remote user through speaker 207. The mechanic may preferably give the remote user a uniform resource location (URL) address for accessing the images capture by either of standard camera 201 or telescoping miniature camera 205. It should be noted that miniature camera 205 may also comprise a fiber optic cable with a light source that sends the image data to a photoreceptor located within monitor station 20. The remote user could then use workstation 23 to access the URL over Internet 22. Communication interface 202 would preferably begin processing and communicating the captured images over Internet 22. Once the remote user accesses the appropriate URL, which may or may not require a password, the remote user would preferably be able to view the images on local display 230.

To view larger field images, the mechanic may preferably use standard camera 201 with its light 204 to illuminate the desired target. Standard camera 201 may preferably be manipulated in certain limited directions to give wide-angle view of large fields or objects. However, the mechanic may also preferably use telescoping miniature camera 205, which may or may not incorporate its own light source, to capture images directly inside the engine of automobile 21. The telescoping mechanism of telescoping miniature camera 205 may comprise a spring assisted coiling system such as shown in reel 208. The mechanic would therefore preferably pull the protective tubing of telescoping miniature camera 205 up to a certain maximum length to capture images at a distance from monitoring station 20.

It should be noted that in alternative embodiments of the present invention, a camera unit may communicate captured image data using a known wireless technology, such as infrared (IR) or some form of radio frequency (RF) link.

By placing telescoping miniature camera 205 into the engine compartment of automobile 21, the mechanic can capture the images of a broken part and have that image processed and communicated over Internet 22 by communication interface 202. Because the remote user can now visually inspect the damaged part through the images displayed on local display 230, which were captured by telescoping miniature camera 205, and is also in voice communication with the mechanic, the remote user can preferably make an informed decision regarding the repair of automobile 21. The ability to see the problem makes the remote user more confident that the mechanic is recommending only necessary repairs. This builds trust between the customer and the mechanic which not only improves the service experience of the consumer but also builds the reputation of the mechanic.

Reinforcing shell 203 also preferably helps prevent damage to monitoring station 20 by preventing water, dirt, corrosive, or caustic materials from contacting the system. It further may preferably provide electronic shielding from any electronic equipment or magnetic motors operating in the area. Thus, reinforcing shell 203 increases the effective life of monitoring station 20 even though it is operated in a more hazardous environment.

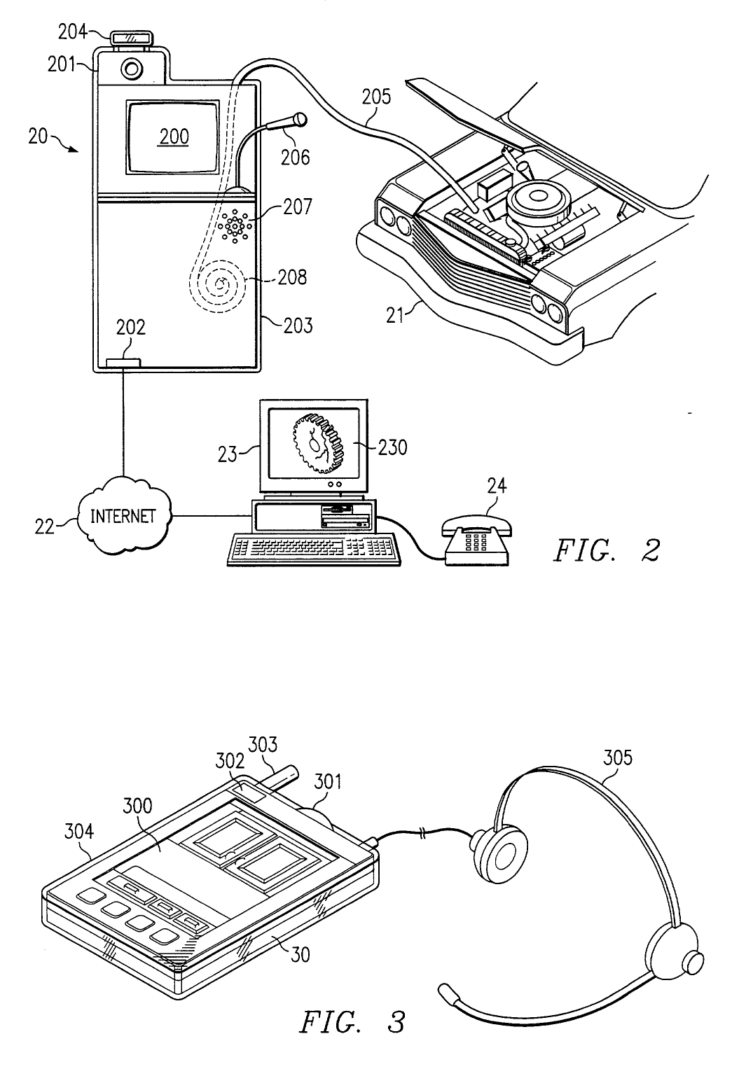

FIG. 3 illustrates a further alternative embodiment configured with a personal data assistant (PDA). Hand monitor 30 preferably includes display 300, camera 301, and protective covering 304. It also preferably includes antenna 303 coupled to communication interface 302 for facilitating wireless communication of multimedia data. In operation of hand monitor 30, the service provider preferably points camera 301 at the desired location, using display 300 to determine when camera 301 is pointed to the correct point. Using any number of different wireless technologies, including Bluetooth™, IEEE 802.11, HomeRF, personal communication service (PCS), and the like, the images captured by camera 301 may preferably be transmitted to a remote customer. In order to facilitate verbal communication, hand monitor 30 is preferably coupled to headset 305 which allows the service provider to hear any speech signals received from the remote customer, as well as sending speech signals to the remote customer.

Protective covering 304 preferably prevents hand monitor 30 from being damaged if it is dropped or if some reasonably sized material falls on it or comes into contact with it. This protection allows the service provider to focus his or her concentration on communicating with the remote customer rather than worrying about taking care of a delicate piece of electronic equipment.

The size of hand monitor 30 also preferably allows the service provider to carry and use the monitoring functionality to any different number of work sites or in smaller locations without the necessity of a more bulky package.

It should be noted that some alternative embodiments may not incorporate a light source. These embodiments would preferably rely on the sensitivity of the camera and the power of the signal processor in the communication interface to capture viewable images. Alternatively, the service provider may supplement the lighting with a flashlight or other portable lighting equipment. Thus the remote monitoring system of the present invention is not limited to incorporating a light source.

It should further be noted that some alternative embodiments of the present invention may not incorporate a handset or other equipment to facilitate audible communication with a remote customer. In such alternative embodiments, the service provider may use a standard telephone or wireless telephone to verbally communicate with the remote customer.

FIG. 4 is a flow chart which relates the steps performed in operating a preferred embodiment of the present invention. In step 400, the equipment comprising the remote monitoring device is preferably reinforced to prevent damage to the system. A network connection is then preferably established between a service provider and a customer in step 401. In step 402, a voice communication link is then established between the service provider and the customer. A service being provided or object to be viewed is illuminated by a light source in step 403. In step 404, images of the service are preferably visually captured. The captured images are then processed in step 405. After processing, the captured images are preferably displayed to the service provider in step 406; preferably communicated to the customer in step 407; and then preferably displayed to the customer in step 408.

1. A visual communication system comprising:
a camera for capturing images;
an electronic display for displaying said images captured by said camera;
a communication interface for communicating said captured images; and
a rugged casing protecting said electronic display, said camera, and said communication interface.

2. The visual communication system of claim 1 further comprising:
an illumination source for use with said camera.

3. The visual communication system of claim 1 wherein said communication interface includes:
a transmitter for facilitating wireless communication.

4. The visual communication system of claim 1 wherein said communication interface supports multimedia communication.

5. The visual communication system of claim 1 wherein said camera is moveable independent from said electronic display and said communication interface.

6. The visual communication system of claim 1 wherein said camera is miniaturized.

7. The visual communication system of claim 1 further comprising:
a microphone for facilitating verbal communication from a user of said system; and
a speaker for playing remote audio signals received by said communication interface.

8. The visual communication system of claim 1 wherein said communication interface includes:
a signal processor for communicating images captured by said camera.

9. A method for remotely monitoring services comprising the steps of:
establishing a network connection between a service provider and a customer;
visually capturing images of services provided by said service provider;
communicating said images to said customer over said network connection; and
reinforcing equipment used in said establishing, visually capturing, and communicating steps.

10. The method of claim 9 further comprising the step of:
displaying said captured images to said service provider.

11. The method of claim 9 wherein said communicating step further comprises the steps of:
processing said images; and
wirelessly transmitting said processed images to said customer.

12. The method of claim 9 further comprising the step of:
establishing a voice communication link between said service provider and said customer.

13. The method of claim 9 further comprising the step of:
illuminating said captured images.

14. The method of claim 9 wherein said captured images comprise multimedia data.

15. A remote monitoring system comprising:
means for capturing visual images;
means connected to said system for displaying said captured visual images;
means for communicating said captured visual images; and
means for ruggedly encasing said system.

16. The system of claim 15 further comprising:
means for illuminating said visual images for capturing.

17. The system of claim 15 wherein said means for communicating includes:
means for wirelessly transmitting said captured visual images.

18. The system of claim 15 further comprising:
means for processing said captured visual images.
